(19) United States
(12) Patent Application Publication
(10) Pub. No.: US 2016/0061228 A1
(43) Pub. Date: Mar. 3, 2016

(54) Valve Arrangement for the Hydraulic Circuit of a Work Machine

(71) Applicant: CATERPILLAR INC., Peoria, IL (US)

(72) Inventors: Nathan J. Lucas, Leicester (GB); William C. Swick, Apex, NC (US); Matthew Gordon, Leicester (GB)

(73) Assignee: Caterpillar Inc., Peoria, IL (US)

(21) Appl. No.: 14/787,347

(22) PCT Filed: May 8, 2014
(86) PCT No.: PCT/US2014/037259

§ 371 Date: Oct. 27, 2015

(30) Foreign Application Priority Data
May 13, 2013 (GB) 1308547.7

(51) Int. Cl. F15B 13/04; F15B 11/08; E02F 9/22; F15B 13/02; F15B 13/044; F15B 11/00; F15B 13/01

(52) U.S. Cl. CPC F15B 13/0401; F15B 11/003; F15B 11/08; F15B 13/015; F15B 13/025; F15B 13/027; F15B 13/044; E02F 9/2285; E02F 9/2289; F15B 2211/25; F15B 2211/40576; F15B 2211/575; F15B 2211/865

(57) ABSTRACT

Valve arrangement includes a pilot operated load control valve fluidly having an energized unidirectional state allowing hydraulic fluid to pass from an outlet to an inlet and a de-energized unidirectional state allowing hydraulic fluid to pass from the inlet to the outlet. A pilot conduit is configured to direct pilot hydraulic fluid to actuate the load control valve. A connecting conduit fluidly connects the pilot conduit to the inlet, the connecting conduit including a flow restriction and a check valve configured to allow hydraulic fluid to flow only in a direction from the pilot conduit towards the inlet.

### TECHNICAL FIELD

This disclosure is directed towards a valve arrangement for a boom control system or for other control systems for work machine components that may be lowered under gravity.

### BACKGROUND

Many construction and agricultural machines utilise hydraulic systems to operate their various mechanical functions. For example, backhoe loaders and excavators typically have a digging bucket on the end of a two-part articulated arm. The two-part articulated arm comprises a ‘boom’, which is mounted on the backhoe loader, and a ‘stick’ (also known as a ‘dipper’), which is articulated to the boom and carries the bucket. The movement of the various components is controlled via hydraulic systems. Hydraulic fluid is directed to hydraulic actuators, such as cylinder-piston arrangements, usually via flexible hoses and various valves.

The hoses used in hydraulic systems on construction and agricultural machines may be at risk of bursting following deterioration due to harsh environmental conditions. When a hose bursts, hydraulic fluid may rapidly escape from the system. In the case of a rupture of a hose that is directly connected to a hydraulic actuator, hydraulic fluid may escape from the actuator. If the actuator controls a machine component that carries a heavy load, such as the boom of a backhoe loader, the loss of hydraulic fluid from the actuator may result in the component dropping uncontrollably. Such uncontrolled dropping of the component may lead to damage and/or injury.

In order to address this issue, ISO 8643 requires the use of a lowering control device associated with the boom-lift cylinder, which is used to control the rising and lowering of the boom. In the event of a burst hose on the boom, the device works automatically to slow or stop any downward movement of the boom.

US-A-2008/0028924 discloses a hydraulic system providing failure protection from a hose burst condition. An isolator is incorporated in a hose adjacent a hydraulic actuator. The isolator includes an electrically operated isolation valve that may prevent hydraulic fluid from escaping from the relevant chamber of the hydraulic actuator in the case of a hose burst condition. This may prevent the boom from dropping uncontrollably.

### SUMMARY

The disclosure therefore provides a valve arrangement for a hydraulic system for raising and lowering a component of a work machine, comprising: an inlet and an outlet; a pilot operated load control valve fluidly connected between the inlet and the outlet, the load control valve having an energised unidirectional state allowing hydraulic fluid to pass from the outlet to the inlet and a de-energised unidirectional state allowing hydraulic fluid to pass from the inlet to the outlet; a pilot conduit configured to direct pilot hydraulic fluid to actuate the load control valve; and a connecting conduit fluidly connecting the pilot conduit to the inlet, the connecting conduit comprising a flow restriction and a check valve configured to allow hydraulic fluid to flow only in a direction from the pilot conduit towards the inlet.

By way of example only, embodiments of a load control valve according to the present disclosure are now described with reference to, and as shown in, the accompanying drawings.

### BRIEF DESCRIPTION OF THE DRAWINGS

FIG. 1 is a side elevation of one type of work machine that may employ a hydraulic system comprising a load control valve according to the present disclosure; and

FIGS. 2 and 3 are schematic representations of one embodiment of a hydraulic system comprising a load control valve according to the present disclosure.

### DETAILED DESCRIPTION

The present disclosure is generally directed towards a valve arrangement for a work machine having one or more booms controlled by a hydraulic system. The valve arrangement may provide a failsafe mechanism for preventing a boom from dropping uncontrollably if a hose burst condition occurs in the hydraulic system.

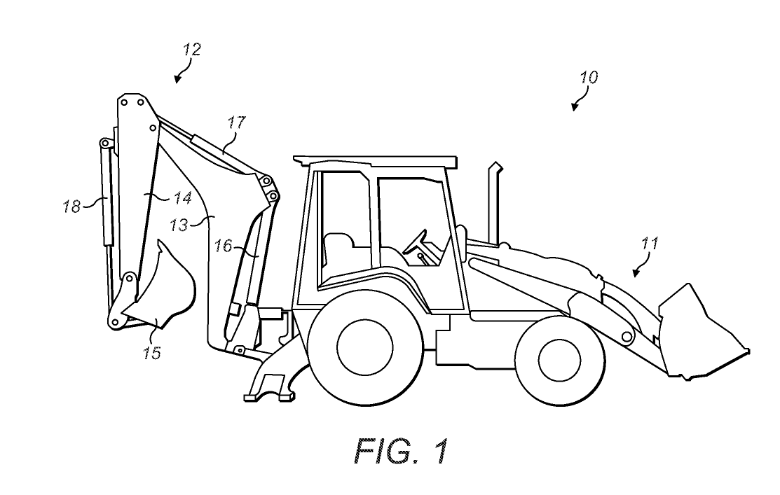

FIG. 1 illustrates one type of work machine 10, in the form of a backhoe loader, having work tools 11, 12. The work tools 11, 12 of a backhoe loader may comprise a loader 11, located at the front of the work machine 10, and a backhoe 12, located at the rear of the work machine 10. The backhoe 12 may be operable to be hydraulically raised and lowered. The backhoe 12 may comprise a boom 13 pivotally mounted at a first end to the work machine 10 for movement in a generally vertical plane. A stick 14 may be pivotally mounted at a first end to the second end of the boom 13 for movement in the same generally vertical plane in which the boom 13 may move. A work implement 15, which may be in the form of a bucket, may be pivotally mounted at a second end of the stick 14 for pivotal movement in the same generally vertical plane in which the boom 13 and stick 14 may move. The boom 13, stick 14, and work implement 15 may be moved using hydraulic actuators 16, 17, 18.

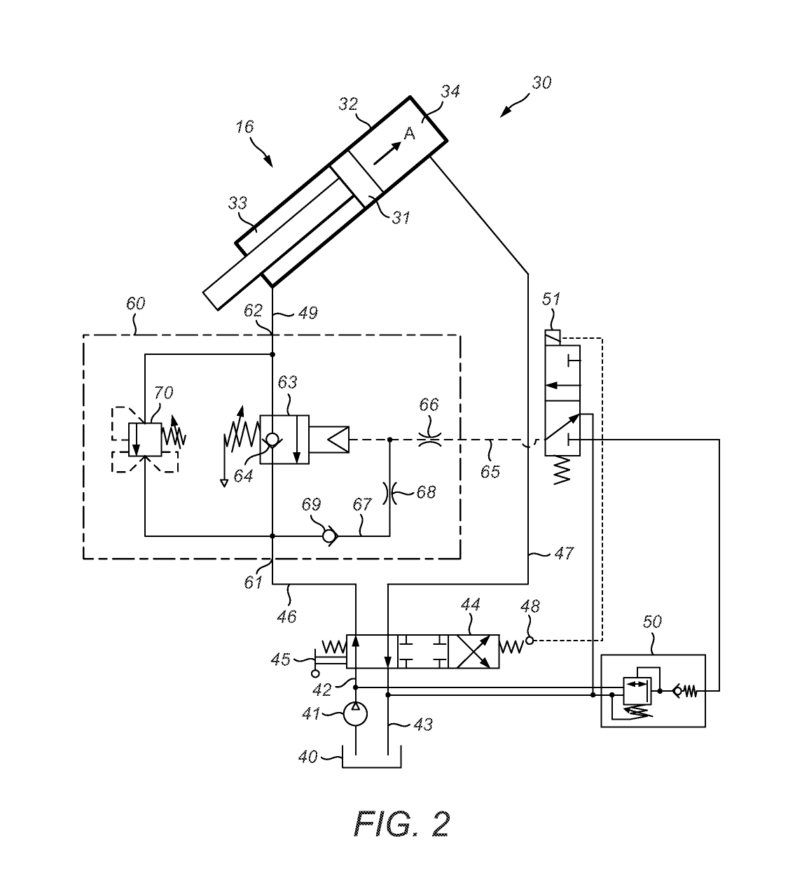

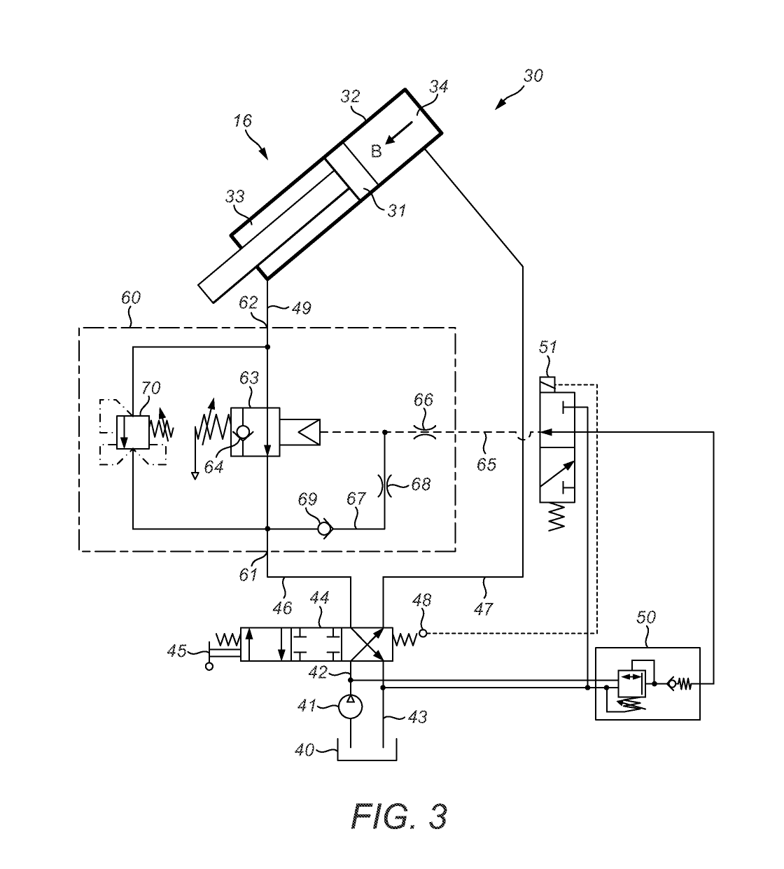

FIGS. 2 and 3 illustrate an embodiment of a simplified hydraulic control system 30 for controlling the raising and lowering of the boom 13 of a work machine 10 via the hydraulic actuator 16. The hydraulic control system 30 may be part of a more extensive hydraulic system (not shown), which may also control the operation of other functions of, and implements on, the work machine 10.

The hydraulic actuator 16 may have a piston 31 slidably located within a cylinder 32. The piston 31 may divide the cylinder 32 into a first chamber 33 and a second chamber 34. By supplying hydraulic fluid to one of the chambers 33, 34, and allowing hydraulic fluid to drain from the other chamber 34, 33, the piston 31 is forced to slide along the cylinder 32 in the direction of the draining chamber 34, 33. This results in the raising or lowering of the boom 13 respectively. It should be noted that the direction of the hydraulic actuator 16 is not important to the invention, and that either the first chamber 33 or the second chamber 34 may be, what is known in the art as, the ‘head chamber’ or the ‘rod chamber’. The description is framed such that supplying hydraulic fluid to the first chamber 33, and draining fluid from the second chamber 34, results in the piston 31 moving in the direction of arrow A (shown on FIG. 2) and a raising of the boom 13. Thus, supplying hydraulic fluid to the second chamber 34, and draining fluid from the first chamber 33, results in the piston 31 moving in the direction of arrow B (shown on FIG. 3) and a lowering of the boom 13.

The hydraulic control system 30 may comprise a source of hydraulic fluid, which source may comprise a tank 40 and a pump 41. The pump 41 may be controlled by a control unit (not shown). The pump 41 may draw hydraulic fluid required by the hydraulic actuator 16 from the tank 40 and force the fluid under pressure into a supply line 42. Any hydraulic fluid drained from the hydraulic actuator 16 may be returned to the tank 40 via a return line 43.

A main control valve 44 may couple the first chamber 33 and second chamber 34 of the hydraulic actuator 16 to the supply and return lines 42, 43. The main control valve 44 may be fluidly connected to the first chamber 33 via a first conduit 46. The main control valve 44 may be fluidly connected to the second chamber 34 of the hydraulic actuator 16 via a second conduit 47. The first and second conduits 46, 47 may be flexible hoses. Thus the main control valve 44 may control the flow of hydraulic fluid to and from the hydraulic actuator 16. The main control valve 44 may be any suitable type of valve, for example a three-position four-way manually controlled valve.

The main control valve 44 may have three operative states. In a first state (not shown), all ports of the main control valve 44 may be blocked such that hydraulic fluid cannot pass through the main control valve 44 and the boom 13 may remain static. In a second state (shown in FIG. 2), the main control valve 44 may allow hydraulic fluid to pass from the supply line 42 to the first chamber 33, and from the second chamber 34 to the return line 43; in this state the boom 13 may be raised. In a third state (shown in FIG. 3), the main control valve 44 may allow hydraulic fluid to pass from the supply line 42 to the second chamber 34, and from the first chamber 33 to the return line 43; in this state the boom 13 may be lowered.

The operative state of the main control valve 44 may be directly selected by the operator of the work machine 10, for example via a lever 45 in the work machine 10. An electrical switch 48, having an ‘on’ position and an ‘off’ position, may be associated with the main control valve 44. For example, the electrical switch 48 may be located on or near the lever 45 used for operating the main control valve 44. The electrical switch 48 may be actuated by movement of the main control valve 44. Moving the main control valve 44 into its third state, for lowering the boom 13, may switch the electrical switch 48 into its ‘on’ position. Moving the main control valve 44 out of its third state, for raising the boom 13 or maintaining the boom 13 static, may switch the electrical switch 48 into its ‘off’ position.

A valve arrangement 60 may be located in the hydraulic control system 30 between the hydraulic actuator 16 and the main control valve 44. The valve arrangement 60 may be connected between the first conduit 46 and the first chamber 33. An inlet 61 of the valve arrangement 60 may be fluidly connectable to the main control valve 44 via the first conduit 46. An outlet 62 of the valve arrangement 60 may be fluidly connectable to the first chamber 33 via a third conduit 49. The third conduit 49 may be a rigid tube. Alternatively, the outlet 62 of the valve arrangement 60 may be directly connected to the first chamber 33. The valve arrangement 60 may be located in close proximity to the first chamber 33. The valve arrangement 60 may be located directly adjacent to the first chamber 33.

Within the valve arrangement 60, a load control valve 63 may be fluidly connected between the inlet 61 and the outlet 62. The load control valve 63 may be unidirectional and may have two states. The load control valve 63 may have a first, de-energised, state. In its de-energised state, an internal check valve 64 (also known as a non-return valve) in the load control valve 63 may allow hydraulic fluid to flow from the main control valve 44 to the first chamber 33 (as shown in FIG. 2). The load control valve 63 may also have a second, energised, state. In its energised state, the load control valve 63 may allow fluid to flow from the first chamber 33 to the main control valve 44 (as shown in FIG. 3).

The load control valve 63 may be energised by pressurised pilot hydraulic fluid supplied by a pilot conduit 65. Any source of pilot hydraulic fluid may be used. For example, pilot hydraulic fluid may be siphoned from the supply line 42 (as shown in FIGS. 2 and 3). A pressure reducing valve 50 may be employed to reduce the pressure of the source of pilot hydraulic fluid to a suitable pressure for the pilot hydraulic fluid. For example, hydraulic fluid in the supply line 42 may have a pressure in the region of up to 250 bar, which may be reduced by the pressure reducing valve 50 to a pressure of approximately 35 bar for the pilot hydraulic fluid.

The supply of pilot hydraulic fluid to the pilot conduit 65 may be determined by the electrical switch 48, which may be electrically connected to a pilot valve 51. The pilot valve 51 may be fluidly connected to the pilot conduit 65. The pilot valve 51 may have two operative states. In its first state (as shown in FIG. 2), the pilot valve 51 may block pressurised hydraulic fluid from entering the pilot conduit 65 and may allow pilot hydraulic fluid to drain from the pilot conduit 65 to the tank 40. In its second state (as shown in FIG. 3), the pilot valve 51 may direct pressurised hydraulic fluid into the pilot conduit 65 and may block pilot hydraulic fluid from draining from the pilot conduit 65 to the tank 40. The pilot valve 51 may be a two-position three-way solenoid valve. The pilot valve 51 may be activated by the electrical switch 48. When the electrical switch 48 is in the ‘off’ position, the pilot valve 51 may be in its first state and hence pressurised pilot hydraulic fluid may be blocked from entering the pilot conduit 65. When the electrical switch 48 is in the ‘on’ position, the pilot valve 51 may be in its second state and hence and hence pressurised pilot hydraulic fluid may be supplied to the pilot conduit 65. Thus the boom 13 may only be lowered when the electrical switch 48 is in the ‘on’ position. Failure of the electrical switch 48 will result in the boom 13 being prevented from being lowered via the load control valve 63.

The pilot conduit 65 may comprise a first flow restriction 66. The first flow restriction 66 may be a fixed orifice or a variable orifice. The first flow restriction 68 may serve to reduce the pressure of the pilot hydraulic fluid in the pilot conduit 65; the reduced pressure set by the first flow restriction 68 may be less than the pressure in the first conduit 46 when the boom 13 descends due to gravity alone. For example, the source of pilot hydraulic fluid may be at a pressure of approximately 35 bar. The first flow restriction 66 may reduce this pressure to, for example, approximately 7 bar. The first flow restriction 66 may also serve to reduce the flow rate of pilot hydraulic fluid in the pilot conduit 65. This may be advantageous as it may reduce the volume of hydraulic fluid that may need to be evacuated from the pilot conduit 65 under a conduit burst condition. The diameter of the first flow restriction 66 is dependent on the desired pressure drop.

A connecting conduit 67 may fluidly connect the pilot conduit 65 to the inlet 61 of the valve arrangement 60. The connecting conduit 67 may connect to the pilot conduit 65 between the first flow restriction 66 and the load control valve 63. The connecting conduit 67 may comprise a check valve 69. The check valve 69 may allow hydraulic fluid to flow in the connecting conduit 67 only in the direction from the pilot conduit 65 to the first conduit 46, and not vice versa. Thus hydraulic fluid will flow from the pilot conduit 65 to the first conduit 46 when the pressure in the first conduit 46 is lower than the pressure in the pilot conduit 65, which is set by the first flow restriction 66. This condition may not occur under normal lowering of the boom 13. However, if the first conduit 46 bursts, the pressure in the first conduit 46 may drop below the pressure in the pilot conduit 65, and hence hydraulic fluid may flow from the pilot conduit 65 to the first conduit 46. This may prevent the load control valve 63 from being in its energised state if the first conduit 46 bursts.

The connecting conduit 67 may further comprise a second flow restriction 68. The second flow restriction 68 may be a fixed orifice or a variable orifice. The second flow restriction 68 may be located between the check valve 69 and the pilot conduit 65. When pilot hydraulic fluid is initially directed to the load control valve 63 to energise it, the pressure in the first conduit 46 may be lower than the pressure in the pilot conduit 65. The second flow restriction 68 may create a pressure drop across it, which may temporarily trap pressure between the first flow restriction 66 and the second flow restriction 68. This may prevent the pilot hydraulic fluid from rapidly escaping from the pilot conduit 65 via the connecting conduit 67. Thus the second flow restriction 68 may serve to maintain the required pressure in the pilot conduit 65 to initially open the load control valve 63. Once the load control valve 63 is energised, the pressure in the first conduit 46 may be greater than the pressure in the pilot conduit 65 and hence pilot hydraulic fluid may not pass from the pilot conduit 65 to the first conduit 46. The diameter of the second flow restriction 68 is dependent on the parameters of the desired pressure drop.

A relief valve 70 may be connected to the first conduit 46 in parallel with the load control valve 63, i.e. between the inlet 61 and the outlet 62 of the valve arrangement 60, as dictated by IS0 8643. The relief valve 70 may be configured to open above a pre-determined pressure threshold. The relief valve 70 may serve to protect the hydraulic actuator 16.

The hydraulic system 30 may be used to control the raising and lowering of components of the work machine 10 other than the boom 13. For example, hydraulic system 30 may be used to control the raising and lowering of the stick 14, and/or the work implement 15.

### INDUSTRIAL APPLICABILITY

The valve arrangement 60 provides control over the lowering of a boom 13 on a work machine 10. The valve arrangement 60 may further be used to prevent uncontrolled dropping of the boom 13 under a conduit burst condition.

During normal raising of the boom 13, an operator of the work machine 10 may select the second state of the main control valve 44 (as shown in FIG. 2). Pressurised hydraulic fluid may be fed to the main control valve 44 by the pump 41 from the tank 40. The main control valve 44 may direct the pressurised hydraulic fluid into the first conduit 46. When the main control valve 44 is in its second state, the electrical switch 48 may be in the ‘off’ position. Thus the pilot valve 51 may not be activated and may be in its first state. In this operative state, no pilot hydraulic fluid may not be supplied to the pilot conduit 65 and the load control valve 63 of the valve arrangement 60 may be in its de-energised state. Hence the hydraulic fluid may pass through the load control valve 63, via its internal check valve 64, to the first chamber 33 of the hydraulic actuator 16. This may cause the piston 31 to slide in the cylinder 32 in the direction of arrow A, which may cause the boom 13 to rise. The movement of the piston 31 may force hydraulic fluid out of the second chamber 34 of the hydraulic actuator 16. This hydraulic fluid may drain through the second conduit 47, via the main control valve 44, to the tank 40.

During normal lowering of the boom 13, the operator of the work machine 10 may select the third state of the main control valve 44 (as shown in FIG. 3). Hydraulic fluid may drain from the first chamber 33 of the hydraulic actuator 16 as the boom 13 lowers due to gravity alone and the piston 31 moves in the direction of arrow B. When the main control valve 44 is in the third state, the electrical switch 48 may be in the ‘on’ position. Thus the pilot valve 51 may be activated and may be in its second state. Thus pilot hydraulic fluid may be supplied to the pilot conduit 65, and hence the load control valve 63 of the valve arrangement 60 may be in the energised state. The hydraulic fluid may therefore pass through the load control valve 63 and the main control valve 44, to drain into the tank 40. During this time, pressurised hydraulic fluid may be fed to the main control valve 44 by the pump 41 from the tank 40. The main control valve 44 may direct the pressurised hydraulic fluid into the second conduit 47, from where it is fed to the second chamber 34 of the hydraulic actuator 16. However, the flow rate of the pump 41 may be limited such that the output of hydraulic fluid from the pump 41 that is supplied to the second chamber 34 may be less than the volume of fluid draining from the first chamber 33. This may ensure that the boom 13 lowers under the force of gravity alone, rather than being powered down. Once the boom 13 has been lowered sufficiently that it has met resistance from the ground, which may be determined by a control unit (not shown), the flow rate of the pump 41 may be increased. Thus further pressurised hydraulic fluid may be supplied to the second chamber 34 of the hydraulic actuator 16 to replace the hydraulic fluid drained from the first chamber 33. This may cause the piston 31 to further slide in the cylinder 32 in the direction of arrow B.

As described above, failure of the electrical switch 48 may prevent the counterbalance valve from being energised, which may in turn prevent the boom 13 from being lowered via the load control valve 63. In this situation, the boom 13 may be powered down via the relief valve 70. This may be done by increasing the flow rate of the pump 41 such that very high pressure hydraulic fluid is pumped into the second chamber 34. This may cause the piston 31 to slide in the cylinder 32 in the direction of arrow B. The movement of the piston 31 may force hydraulic fluid out of the first chamber 33 of the hydraulic actuator 16. The hydraulic fluid may not be able to pass through the de-energised load control valve 63, which may result in a pressure at the outlet 62 of the valve arrangement 60 which is greater than the pre-determined pressure threshold of the relief valve 70. Thus the relief valve 70 may open and hydraulic fluid may drain to the tank 40, via the first conduit 46 and the main control valve 44. Hence the boom 13 may be lowered.

If the operator of the work machine 10 selects the first state of the main control valve 44, no hydraulic fluid may pass through the main control valve 44. Hence the boom 13 remains static. Additionally, when the main control valve 44 is in its second state, the electrical switch 48 may be in the ‘off’ position. Thus the pilot valve 51 may not be activated and may be in its first state. Thus pilot hydraulic fluid may not be supplied to the pilot conduit 65 and the load control valve 63 of the valve arrangement 60 may be in its de-energised state.

It is possible that a conduit 46, 47, 49 may burst when raising the boom 13. The construction of the third conduit 49, and/or its close proximity to the first chamber 33, may mean that it is unlikely to burst. However, there remains a risk that the first conduit 46 may burst. When raising the boom 13, the load control valve 63 may be in its de-energised state. Thus the internal check valve 64 of the load control valve 63 may prevent hydraulic fluid from escaping from the first chamber 33. Hence the boom 13 may be prevented from suddenly dropping. The boom 13 may then be powered down in a controlled manner via the relief valve 70. In the case that the second conduit 47 bursts, hydraulic fluid may escape from the second chamber 34, which may result in a greater pressure differential between the first chamber 33 and the second chamber 34. This may cause the boom 13 to rise. This would not carry the same risk as if the boom 13 were to drop uncontrollably.

It is also possible that a conduit 46, 47, 49 may burst when lowering the boom 13. Again, the third conduit 49 is unlikely to burst. However, there remains a risk that the first conduit 46 may burst. When lowering the boom 13, the load control valve 63 may be in the energised state, with hydraulic fluid passing from the first chamber 33 towards the main control valve 44. The conduit burst condition may cause the pressure in the first conduit 46 to suddenly drop. This may result in the pressure in the first conduit 46 being lower than the pressure in the pilot conduit 65. Thus the pilot hydraulic fluid in the pilot conduit 65 may pass through the connecting conduit 67 into the first conduit 46, via the check valve 69. Hence the pilot hydraulic fluid may be prevented from acting on the load control valve 63, which may de-energise the load control valve 63. With the load control valve 63 in its de-energised state, the internal check valve 64 of the load control valve 63 may prevent hydraulic fluid from escaping from the first chamber 33. Hence the boom 13 may be prevented from suddenly dropping. The boom 13 may then be powered down in a controlled manner via the relief valve 70. In the case that the second conduit 47 bursts, hydraulic fluid may escape from the second chamber 34, which may result in a greater pressure differential between the first chamber 33 and the second chamber 34. This may cause the boom 13 to rise.

It is further possible that a conduit 46, 47, 49 may burst when the boom 13 is static, i.e. when the main control valve 44 is in the first state. When the boom 13 is static, the load control valve 63 may be in its de-energised state. Thus, if the first conduit 46 bursts, the internal check valve 64 of the load control valve 63 may prevent hydraulic fluid from escaping from the first chamber 33. Hence the boom 13 may be prevented from suddenly dropping. The boom 13 may then be powered down in a controlled manner via the relief valve 70. In the case that the second conduit 47 bursts, hydraulic fluid may escape from the second chamber 34, which may result in a greater pressure differential between the first chamber 33 and the second chamber 34. This may cause the boom 13 to rise.

It is possible that the boom 13 may be subjected to unintentional impact, such as if the boom 13 strikes an object. In such a situation, the resultant force may cause an excessively high pressure in the first or second chamber 33, 34 of the hydraulic actuator 16. During raising of the boom 13, the load control valve 63 may be de-energised. Therefore, if an excessively high pressure occurs in the first chamber 33 during raising of the boom 13, hydraulic fluid may not be able to drain from the first chamber 33 due to the internal check valve 64 in the load control valve 63. Hence the pressure may be trapped in the first chamber 33. This may cause severe damage to the hydraulic actuator 16. To avoid such damage, the relief valve 70 may be configured to open when the pressure in the first chamber 33, and hence at the outlet 62 of the valve arrangement 60, exceeds a pre-determined threshold. This may enable hydraulic fluid to drain from the first chamber 33 via the relief valve 70 when the pre-determined threshold is surpassed, thereby avoiding damage to the hydraulic actuator 16. If an excessively high pressure occurs in the first chamber 33 during lowering of the boom 13, when the load control valve 63 is energised, hydraulic fluid may drain from the first chamber 33 through the load control valve 63 to the tank 40. If an excessively high pressure occurs in the second chamber 34 during either raising or lowering of the boom 13, hydraulic fluid may escape from the second chamber 34 to the tank 40. Hence, in those situations, the hydraulic actuator 16 would not be at risk of damage.

1. A valve arrangement for a hydraulic system for raising and lowering a component of a work machine, comprising:
an inlet and an outlet;
a pilot operated load control valve fluidly connected between the inlet and the outlet, the load control valve having an energized unidirectional state allowing hydraulic fluid to pass from the outlet to the inlet and a de-energized unidirectional state allowing hydraulic fluid to pass from the inlet to the outlet;
a pilot conduit configured to direct pilot hydraulic fluid to actuate the load control valve; and
a connecting conduit fluidly connecting the pilot conduit to the inlet, the connecting conduit comprising a flow restriction and a check valve configured to allow hydraulic fluid to flow only in a direction from the pilot conduit towards the inlet.

2. A valve arrangement according to claim 1, wherein the flow restriction in the connecting conduit is an orifice.

3. A valve arrangement according to claim 1, wherein the pilot conduit comprises a flow restriction.

4. A valve arrangement according to claim 3, wherein the flow restriction in the pilot conduit is an orifice.

5. A valve arrangement according to claim 1, further comprising a relief valve connected between the inlet and the outlet in parallel with the load control valve.

6. A hydraulic system with component failure protection comprising:
a hydraulic fluid source;
a hydraulic actuator having a first chamber; and
a valve arrangement according any of the preceding claims fluidly connected between the hydraulic fluid source and the first chamber, such that the inlet of the valve arrangement is between the hydraulic fluid source and the load control valve, and the outlet of the valve arrangement is between the load control valve and the first chamber.

7. A hydraulic system according to claim 6, wherein the valve arrangement is located adjacent the first chamber.

8. A hydraulic system according to claim 6, further comprising an electrical switch operable to supply the pilot conduit with pilot hydraulic fluid.

9. A hydraulic system according to claim 6, further comprising a pilot valve fluidly connected to the pilot conduit, the pilot valve having a first state in which pilot hydraulic fluid is blocked from entering the pilot conduit and a second state in which pilot hydraulic fluid is directed to the pilot conduit.

10. A hydraulic system according to claim 15, wherein the electrical switch is operable to activate the pilot valve.

11. A hydraulic system according to claim 6, further comprising a main control valve between the load control valve and the hydraulic fluid source.

12. A hydraulic system according to claim 16, wherein the electrical switch is actuated by movement of the main control valve.

13. A hydraulic system according to claim 6, wherein pilot hydraulic fluid is siphoned from the hydraulic fluid source via a pressure reducing valve.

14. A hydraulic system according to claim 6, wherein the hydraulic actuator further comprises a second chamber fluidly connected to the hydraulic fluid source.

15. A hydraulic system according to claim 8, further comprising a pilot valve fluidly connected to the pilot conduit, the pilot valve having a first state in which pilot hydraulic fluid is blocked from entering the pilot conduit and a second state in which pilot hydraulic fluid is directed to the pilot conduit.

16. A hydraulic system according to claim 8, further comprising a main control valve between the load control valve and the hydraulic fluid source.

17. A hydraulic system according to claim 7, further comprising an electrical switch operable to supply the pilot conduit with pilot hydraulic fluid.

18. A hydraulic system according to claim 17, further comprising a pilot valve fluidly connected to the pilot conduit, the pilot valve having a first state in which pilot hydraulic fluid is blocked from entering the pilot conduit and a second state in which pilot hydraulic fluid is directed to the pilot conduit.

19. A valve arrangement according to claim 2, wherein the pilot conduit comprises a flow restriction.

20. A valve arrangement according to claim 4, further comprising a relief valve connected between the inlet and the outlet in parallel with the load control valve.
